(19) United States
(12) Patent Application Publication
(10) Pub. No.: US 2017/0320702 A1
(43) Pub. Date: Nov. 9, 2017

(54) METHOD FOR PROCESSING CALL INPUTS BY AN ELEVATOR CONTOLLER AND ELEVATOR SYSTEMS FOR IMPLEMENTING THE METHOD

(71) Applicants: ThyssenKrupp Elevator AG, Essen (DE); ThyssenKrupp AG, Essen (DE)

(72) Inventors: Stefan Gerstenmeyer, Filderstadt (DE); Stefan Schneider, Filderstadt (DE)

(73) Assignees: ThyssenKrupp Elevator AG, Essen (DE); ThyssenKrupp AG, Essen (DE)

(21) Appl. No.: 15/524,865

(22) PCT Filed: Oct. 28, 2015
(86) PCT No.: PCT/EP2015/074944

§ 371 Date: May 5, 2017

(30) Foreign Application Priority Data
Nov. 13, 2014 (DE) 10 2014 223 153.1

(51) Int. Cl. B66B 1/14; B66B 1/24; B66B 1/52; B66B 1/34; B66B 1/46

(52) U.S. Cl. CPC B66B 1/14; B66B 1/3438; B66B 1/468; B66B 1/52; B66B 1/2458; B66B 2201/103; B66B 2201/104; B66B 2201/304; B66B 2201/101

(57) ABSTRACT

The invention relates to a method for the processing of call inputs of a user by an elevator controller of an elevator installation in which a user inputs either an external call and an internal call or a destination call into the elevator controller, wherein the elevator controller generates at least two sub-calls in reaction to the internal call or the destination call, wherein the sub-calls comprise at least one external call and/or at least one internal call whose destination floor is different from the destination floor of the internal call input by the user. The invention furthermore relates to a method in which an elevator controller generates a destination call or an internal call in reaction to an external call. The invention furthermore relates to corresponding elevator installations designed for carrying out these methods.

The present invention relates to methods for the processing of call inputs by an elevator controller of an elevator installation in which a call input by a user is processed by the elevator controller, and to an elevator installation for carrying out the methods.

Intelligent elevator controllers are used for optimizing the transport capacity of elevator installations in high buildings. By way of example, it is known to use feeder or shuttle elevators which interact with local distribution groups. Such feeder elevators typically only have two stops, for example the ground floor and the n-th floor, wherein n can be a number between 10 and 30, for example. In this case, the n-th floor serves as an transfer floor to which the local distribution groups also move. The cars of the local distribution group are movable for example between the n-th floor and the n+m-th floor, wherein every intervening floor can be moved to here (wherein m can be a number between 10 and 30, for example).

It is furthermore known to operate such elevator installations with a destination call control in which a user inputs a destination floor from the start floor, that is to say from outside the car. In this case, such a destination call is allocated a first car, which brings the user firstly to the transfer floor. Upon or shortly before reaching the transfer floor, the user or the call is automatically allocated a second car and notified thereof, which second car has to be used by said user from the transfer floor in order to reach the user's destination floor. Such operation of an elevator installation is referred to as zone operation.

EP 1 491 481 A1 discloses a method for the control of an elevator installation operated in zone operation. Said elevator installation uses a destination call control in which a multi-group controller, by means of a destination call input, allocates a feeder elevator depending on the number of traveling destinations of the feeder elevator in a first zone and depending on the number of traveling destinations of the passengers allocated to a feeder elevator in a second zone.

A further elevator controller for an elevator system operated in zone operation is known from U.S. Pat. No. 7,128,190 B2.

The problem addressed by the present invention shall be explained further on the basis of an exemplary elevator installation: it shall be assumed below that an elevator installation is subdivided into two zones, wherein a transition from a first zone to a second zone is possible on a transfer floor. In order to reach the transfer floor, a group of feeder cars are provided which serve only the ground floor and the transfer floor. The feeder cars thus bridge the first zone.

A local distribution group, likewise comprising a plurality of cars, is provided for serving the second zone. It should be noted in this context that, of course, a local distribution group can also be provided for serving further floors of the first zone.

By way of example, the illustrated elevator installation shall furthermore be embodied with a destination call control. It shall be assumed that a user would like to be transported from the ground floor to a floor of the second zone.

Using the terminology introduced above, therefore, a cross-zone destination call is divided into two or more sub-destination calls. In this case, a first car from the group of feeder cars is allocated to the first sub-destination call, and a subsequent car, which is part of the local distribution group, is allocated to the further sub-destination call.

The processing of such a destination call in the form of two sub-destination calls proves to be relatively inflexible and therefore non-optimal for specific applications, since a specific car has to be fixedly allocated to the first sub-destination call as early as when the cross-zone destination call is input. This restricts the flexibility or adaptability of the elevator installation to variable traffic situations and also the flexibility of the user.

The invention strives to improve the processing of call inputs of a user.

The terms external call, internal call and destination call used in connection with the method according to the invention shall be defined hereinafter as follows:

An external call (so-called “hall call”) is firstly a call initiated by a user from outside a car, that is to say generally from the floor, said call not comprising an input of a destination floor. This can be a call which only requests a car or already includes a desired journey direction (in the upward or downward direction). An external call generated by the elevator controller is an automatically generated call which contains the corresponding information. An external call generated by the elevator controller is typically generated if a user is outside a car, for example on an transfer floor. However, the term “external call generated by the elevator controller” also encompasses corresponding calls which are generated by the elevator system while the user is still situated within a different car. The criterion characterizing all forms of an external call is the information content mentioned (request of a car without inputting of a destination floor, if appropriate comprising a direction input).

An internal call (so-called “car call”) is firstly a call which is made by the user within a car and which comprises or determines a destination floor. An internal call generated by the elevator controller is an automatically generated call of this type which is generated while a user is situated in a car.

The term destination call has already been used. This is a call which is initiated from outside a car and which comprises a destination floor. Such a destination call can be initiated by a user or can be automatically generated by the elevator controller. The term “destination call” in particular also encompasses calls which are generated by the elevator controller while a user is not yet situated in a car, that is to say before said user has entered a car.

The term “destination call” in particular also encompasses calls having a corresponding information content which are generated by the elevator controller while a user is situated in a specific car, but the call is assigned to a different car.

The invention proposes a method for the processing of call inputs of a user by an elevator controller of an elevator installation in which a user inputs either an external call and an internal call or a destination call into the elevator controller, wherein the elevator controller generates at least two sub-calls in reaction to the internal call or the destination call, wherein the sub-calls comprise at least one external call and/or at least one internal call whose destination floor is different from the destination floor of the internal call input by the user.

The invention furthermore proposes a method for the processing of call inputs of a user by an elevator controller of an elevator installation in which a user inputs an external call into the elevator controller, wherein the elevator controller generates a destination call or an internal call in reaction to the external call.

The invention furthermore proposes an elevator installation designed for carrying out at least one of the methods according to the invention.

The methods according to the invention allow a very flexible processing of calls of a user. An elevator system is thereby able to react significantly more flexibly to altered or variable traffic conditions and thus to optimize the transport capacity.

The dependent claims relate to advantageous configurations of the methods according to the invention.

The first method according to the invention is usable in particular for the control of an elevator installation operated in zone operation, wherein the floors to which the elevator installation moves are subdivided into at least two zones, wherein in each case at least one interchange floor is provided for a transition between the zones (in the case of a cross-zone call). In the case of an elevator installation which is operated in zone operation in this way and in which a user inputs a cross-zone call from a start zone to a destination zone, a significantly more flexible assignment of cars in the start zone and the destination zone which the user enters after changing on the transfer floor is possible. According to the invention, the car to be assigned in the start zone and/or destination zone can be assigned significantly later and/or more flexibly than was possible in conventional solutions.

In accordance with one preferred embodiment, the method comprises the following steps:
inputting of an external call by a user on a start floor,
provision of a first car by the elevator controller on the start floor,
after entry of the user into the first car, inputting of an internal call comprising the destination floor by the user, in particular after a request conveyed to the user to input a destination floor,
travel of the first car to a transfer floor,
generation of a destination call by the elevator controller from the transfer floor to the destination floor,
assignment of a second car to the destination call,
provision of the assigned second car on the transfer floor, and
after entry of the user into the second car, travel of the assigned second car to the destination floor.

This method is advantageous in particular for the so-called “incoming situation”, in which a user inputs an external call into the elevator controller from an entrance level, wherein a start zone in which the entrance level is situated is served by means of shuttle elevators that can stop only at the entrance level and a transfer floor. The use of a circulating and/or shaft-changing multi-car system as shuttle elevator system is also envisaged as a further advantageous solution. Via the transfer floor, the start zone is connected to a destination zone embodied as a local distribution group. The advantage of this embodiment is, in particular, that the assignment and provision of a car in the local distribution group can be carried out independently of the operation of the shuttle cars in the start zone. In particular, an assignment and provision of a car in the local distribution group can be carried out in a manner offset in time with respect to the entry of a shuttle car by a user.

In accordance with a further preferred embodiment of the method, said method comprises the following steps:
inputting of a destination call defining a destination floor by a user on a start floor,
generation of a sub-destination call by the elevator controller from the start floor to a transfer floor,
provision of a first assigned car on the start floor,
travel of the first assigned car to the transfer floor,
generation of an external call for the transfer floor by the elevator controller,
provision of a second car assigned to the external call by the elevator controller,
after entry of the user into the second car, inputting of an internal call by the user, in particular after a request for the inputting of an internal call by the user, or automatic generation of a call by the elevator controller, and
travel of the car to the destination floor.

With this embodiment, in particular the so-called “outgoing situation” is processed advantageously, in which users would like to be transported from an (upper) floor of a building to an entrance level by inputting a cross-zone call. In this case, an automatic generation of a call by the elevator controller is advantageous in particular if logically only a unique destination floor is possible.

In accordance with a further advantageous configuration of the method according to the invention, said method comprises the following steps:
inputting of an external call by a user on a start floor,
provision of a first car by the elevator controller on the start floor,
after entry of the user into the first car, inputting of an internal call to the destination floor by the user, in particular after a request for the inputting of an internal call to the destination floor by the user,
for the case where the elevator controller recognizes that the first assigned car cannot move to the destination floor, generation of a modified internal call by the elevator controller to a floor to which the first car can move,
generation of an external call for the modified floor by the elevator controller,
provision of a second car in reaction to the external call on the modified floor,
after entry of the user into the second assigned car, inputting of a further internal call by the user to the destination floor, in particular after a request for the inputting of a corresponding internal call by the user, or automatic generation of a call by the elevator controller, and
travel of the second car to the destination floor.

This embodiment can be used advantageously in the case of an elevator installation in which not every car can move to every floor, in order to reduce the call input devices to be provided on each floor.

In accordance with a further advantageous configuration of the method, instead of the generation of an external call for the modified floor and the subsequent inputting of a further internal call, a destination call is to be generated by the elevator controller.

According to the invention, as a further solution in the case of the inputting of an external call by a user into the elevator controller, a destination call or an internal call is automatically generated. This procedure is particularly advantageous if only a unique destination floor is logically possible in the current operating state of the elevator. In this case, the system can independently generate an internal call when a passenger enters the elevator. Such automatic generation of an internal call after an external call has similarities with a destination call, but affords an advantage insofar as a car is not immediately allocated to the external call when the external call is registered. Until a car actually arrives, a redistribution can take place in the background. However, a further configuration also provides for a destination call to be generated in response to such an external call already before the user enters a car. The automatic generation both of an internal call and of a destination call offer the user simple handling of an elevator system and thus increase convenience.

Further advantages and configurations of the invention are evident from the description and the accompanying drawing.

It goes without saying that the features mentioned above and those yet to be explained below can be used not only in the combination respectively indicated, but also in other combinations or by themselves, without departing from the scope of the present invention.

The invention is illustrated schematically on the basis of exemplary embodiments in the drawing and is described in detail below with reference to the drawing.

### DESCRIPTION OF THE FIGURES

In the figures:

FIG. 1 shows a graph for illustrating a first preferred embodiment of the method according to the invention,

FIG. 2 shows a graph for illustrating a second preferred embodiment of the method according to the invention, and

FIG. 3 shows a graph for illustrating a third preferred embodiment of the method according to the invention.

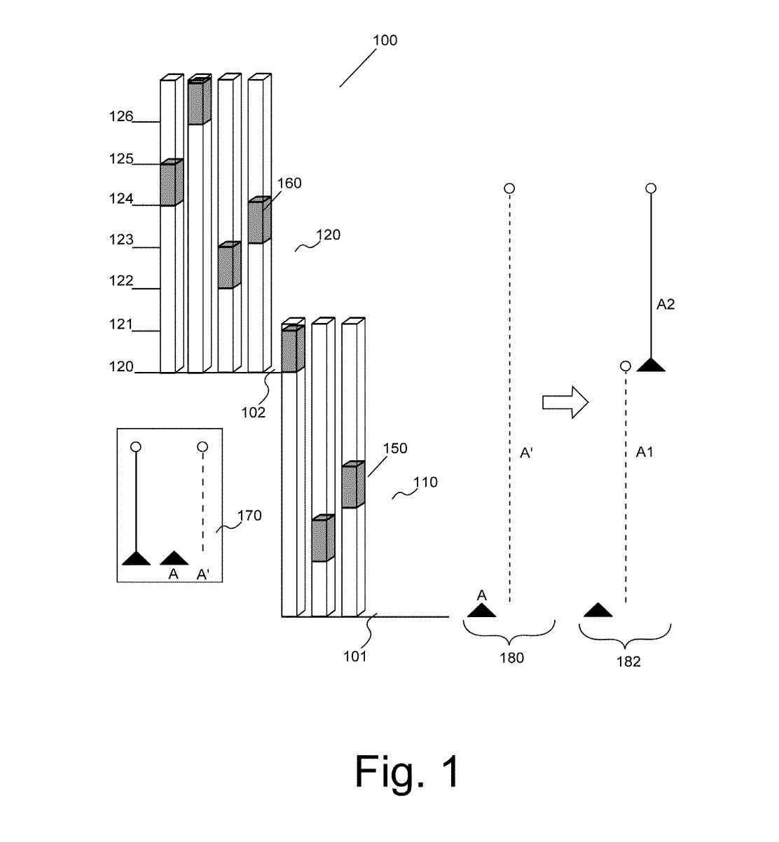

An elevator system suitable for carrying out the method according to the invention is designated in its entirety by 100 in FIG. 1. The elevator system operates in zone operation and has a lower zone 110 and an upper zone 120. An entrance level, which serves as a start floor in the present exemplary embodiment, is designated by 101. Three cars 150 are provided in the lower zone 110, said cars being embodied as shuttle cars and being movable between the entrance level 101 and a transfer floor 102. It shall be assumed that the cars 150 in this exemplary embodiment have only two stopping possibilities, namely entrance level 101 and transfer floor 102.

Transfer floor 102 is, by way of example, the 20th floor of the building in which the elevator system is installed.

In the second zone 120, the lowest floor of which is the transfer floor 102, a plurality of cars 160 are likewise movable. The cars 160 can in each case move to each floor 120-126 of the second zone 120, that is to say form a local distribution group.

A user inputs an external call A (symbolized as a triangle) at the entrance level 101. The elevator controller, which is illustrated schematically and designated by 170, allocates one of the cars 150 of the lower zone 110 to this external call. The allocated car 150 is provided on the entrance floor, an entry arrow and/or gong typically being used for notification of the allocated car.

After the user has entered the assigned car 150, the user (within the car) makes an internal call that defines the destination floor of the user. The internal call is illustrated by means of a dashed line with a circle symbolizing the destination floor and is designated by A′. The calls input by the user, that is to say external call A and internal call A′, are designated jointly by 180.

It should be noted that, for example, for the case where the shuttle cars are in continuous operation at peak times, or one of the cars 150 is already available with an open door at the entrance level 101, the user can simply (that is to say without inputting an external call) enter this car. Only the internal call A′ is then carried out within the car.

In the present example it shall be assumed that the destination floor of the user is the 24th floor, designated by 124 in the example illustrated.

The inputting of the external call A and/or of the internal call A′ can be carried out e.g. by key, button or touch screen, or automatically/contactlessly, for example by means of a card reader or wireless reading of an ID transponder of the user.

The assigned car 150 (shuttle or feeder car) subsequently transports the user to the transfer floor 102. It should be noted that, of course, a plurality of transfer floors can also be provided, for example if the elevators 150 can serve a plurality of transfer floors.

To carry out this transport, the elevator controller 170 firstly generates an internal call A1 from the entrance level 101 to the transfer floor 102. The internal call A1 is in turn illustrated by means of a dashed line with a circle for the destination floor. Shortly before or upon reaching the transfer floor 102, the elevator controller 170 automatically generates a subsequent call in the form of a destination call A2. The destination call is symbolized by means of a triangle at the start floor of the destination call (that is to say the transfer floor 102 in the present case), solid line and circle (for the destination floor). The two calls generated by the elevator controller are designated jointly by 182.

The destination call A2 is allocated an elevator 160 of the local distribution group of the upper zone 120. This allocation of a car 160 for the user is carried out either immediately while the user is in the car 150, or at a later point in time, for example while the user is on the transfer floor 102, e.g. while the car in which the user is situated approaches the transfer floor, in particular during the deceleration phase of the car. A corresponding indication for the user is effected for example in the car 150 or on the transfer floor 102.

It should again be noted that this call A2 for the assigned car 160 of the upper zone constitutes a destination call since it is generated by the elevator controller before the user enters said car 160.

It should be noted that the allocation of a car 160 can also be carried out in a personalized manner, for example if the external call or internal call A or A′ input by the user was made in a personalized manner. Such a personalized call can be effected via a smartphone, for example.

The advantage of the method presented here by comparison with conventional cross-zone destination call systems is, in particular, that a unique assignment of a shuttle car 150 before a shuttle car is entered is not necessary. Therefore, an overall destination of a user need not be registered by the elevator controller beforehand.

The method according to the invention fosters the effective operation of the shuttle cars 150, which operate optimally if they are fully loaded. An individual allocation of shuttle cars such as is customary in the case of conventional cross-zone destination call systems reduces the effectiveness of the operation of the shuttle cars. On the other hand, the method according to the invention utilizes the known advantages of a destination call system for the subordinate distribution group in the upper zone 120.

The first embodiment of the method according to the invention as illustrated above optimizes the so-called “incoming situation”, in which a user or a multiplicity of users enter(s) a building and is/are intended to be transported to different floors as efficiently as possible.

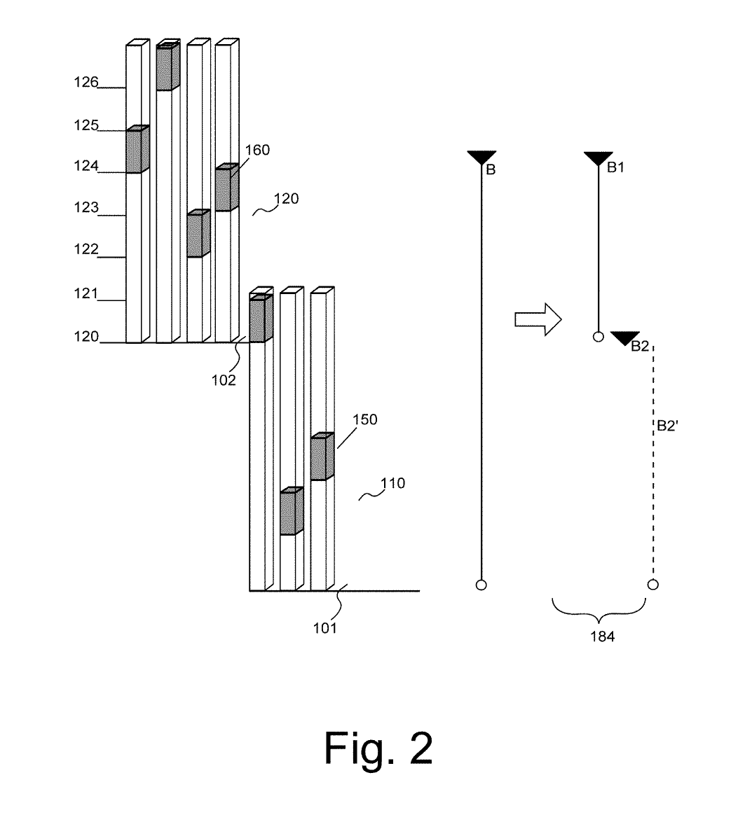

A further preferred embodiment of the method according to the invention is illustrated in FIG. 2. The situation illustrated here corresponds to the so-called “outgoing situation”, in which users are intended to be transported from individual floors to a common floor, for example the entrance level.

The elevator system illustrated corresponds to the elevator system in accordance with FIG. 1, the same reference signs also being used.

It shall be assumed here that a user is on the floor 124 of the upper zone 120, that is to say in the region of the local distribution group, and would like to be transported to the entrance level 101.

At the user's start floor (in the present example the 24th floor, once again designated by 124), the user inputs a destination call B into the elevator controller. The destination call B is therefore a cross-zone call which results firstly in a journey in a car 160 of the upper zone, and then in a journey in a car 150 of the lower zone. The elevator controller 170 generates a sub-destination call B1 to the transfer floor 102 in reaction to said destination call B. A car 160 is allocated to said sub-destination call B1 and is provided for the user on the start floor 124. The user enters the assigned car 160, which is thereupon moved to the transfer floor 102. Before or upon reaching the transfer floor 102, the elevator controller automatically generates an external call B2 for the subsequent group, that is to say here the shuttle cars 150 of the first zone 110, such that one of the shuttle cars 150 can react to said external call.

A corresponding shuttle car is provided on the transfer floor 102. The user can then input the user's destination floor as internal call B2′ in said car 150. The calls B1, B2 and B2′ that are generated or input as a consequence of the destination call B are designated jointly by 184. As an advantageous configurational variant provision is likewise made for the elevator controller to automatically generate such an internal call. This automatic generation is advantageously carried out if the destination is unique. This automatic generation of an internal call can be extended to the effect that the external call is already generated automatically, wherein said external call contains destination location information and is correspondingly registered at a car. This does not involve a traditional destination call with direct allocation of the elevator.

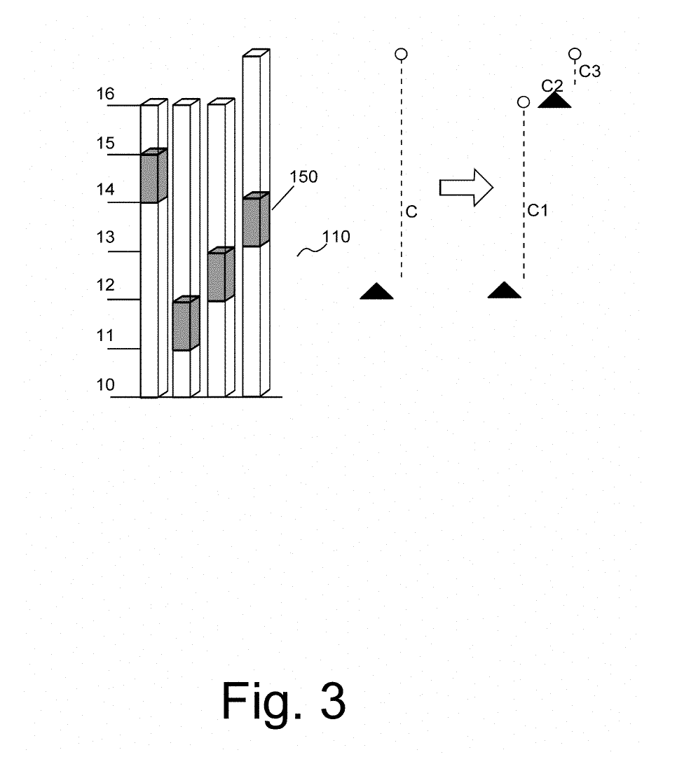

With reference to FIG. 3, a further preferred embodiment of the method according to the invention is illustrated. Only one zone is necessary for illustrating this embodiment, said zone being designated again by 110 here for the sake of simplicity. The cars assigned to this zone are in turn designated by 150. The cars 150 serve floors designated by 10-16.

In certain elevator groups it occasionally happens that not all cars can serve all stops or floors. Previous solutions made provision here for providing on each floor corresponding external call keys via which different cars which serve every floor overall can be called. However, such provision of a relatively large number of external call keys easily leads to deliberate or unwitting misuse, for example if two keys are actuated simultaneously. This restricts the effectiveness of the system overall and leads to additional costs on each floor.

The exemplary embodiment of a method according to the invention as explained in association with FIG. 3 is distinguished by the fact that each of the cars 150 has an input device for initiating internal calls, with which input device each floor 10-16 can be chosen as destination floor, even if the specific car in which a user is situated cannot actually serve a floor thus chosen. For the case where an internal call C is initiated for a floor that cannot be served by a car, the elevator controller 170 generates a modified internal call C1 for moving the car to a suitable interchange floor. At the interchange floor, the elevator controller 170 then generates an external call C3 that can be answered only by cars from the group which can reach the destination floor already known. In this case, the user may be requested to input the user's destination floor (as internal call C3) again after changing to a second car. In particular provision is also made for such an internal call to be automatically generated by the elevator controller 170. As a further advantageous configuration, provision is made for the generation of this second call (from the interchange floor) as a destination call. In the present example, the user would like to be conveyed from floor 12 to floor 16. The modified internal call, as illustrated above, conveys the user firstly to floor 15.

The advantage of this solution is, in particular, that additional call keys need not be provided on every floor. Moreover, it can be assumed that an improper actuation by multiple actuation of call keys is largely reduced.

Finally, reference shall be made to a further advantageous embodiment of the method according to the invention: in the case of a direction-sensitive collective control with conventional external call keys, firstly the user initiates an external call from the floor, and subsequently, after a car has been provided in reaction to this external call, the user initiates an internal call in the car. However, if only a uniquely defined destination for an elevator system or a car is possible in a current operating state, the elevator controller can automatically generate such an internal call when the user enters the car. A direction-sensitive collective control is understood to mean, in particular, an elevator system having groups of up/down external call keys.

Such automatic generation of an internal call after an external call initiated by the user has similarities with a destination call, but affords the major advantage that a specific car does not have to be allocated immediately when the external call is initiated. Even after the initiation of the external call, the system is able to carry out a redistribution or reassignment of a car for such an external call, without the user having to be informed of this. The allocation of a corresponding car is carried out in accordance with a traditional collective control. In this case, the function can also be regarded as a convenience function. In the case of elevator installations having only two possible stopping floors, each external call has a unique destination.

This function can also be used in conjunction with a destination control. In this case, by way of example, if a basement is present, on the ground floor there is an additional external call key in the downward direction.

It should be pointed out that the embodiments described are provided for application in particular also in multiple-car systems in which, for example, a plurality of cars arranged one above another are movable independently of one another in a common shaft. In particular, the shuttle cars 150 can be embodied in the form of a group of single-car shafts in which each shaft is assigned only a single car, double-decker shafts in which each shaft is assigned a double-decker car, twin shafts in which each shaft is assigned two or more cars movable one above another independently of one another, or else as shaft-changing multiple-car systems. It is also possible to provide only one shaft for the shuttle cars.

A convenience function collective control can also be used in the case of individual cars. Corresponding displays for informing users about the system behavior of a car or of the elevator system can be fitted in elevator cars and elevator lobbies.

1.-9. (canceled)

10. A method for processing call inputs with an elevator controller of an elevator installation wherein
in an incoming scenario where one or more users enter a building and intend to travel to one or more floors of the building, the method comprises:
receiving an external call of a user on a start floor,
providing a first car by the elevator controller on the start floor,
receiving an internal call of the user that specifies a destination floor after the user enters the first car,
moving the first car to a transfer floor,
generating a destination call by the elevator controller from the transfer floor to the destination floor,
assigning a second car to the destination call,
providing the second car on the transfer floor, and
moving the second car to the destination floor after the user enters the second car; and
in an outgoing scenario where one or more users intend to travel from various floors of a building to a common floor, the method comprises:
receiving a destination call of a user on a start floor, the destination call specifying a destination floor,
generating a sub-destination call by the elevator controller from the start floor to a transfer floor,
providing a first assigned car to the start floor,
moving the first assigned car to the transfer floor,
generating an external call by the elevator controller for the transfer floor,
providing a second car assigned to the external call by the elevator controller to the transfer floor,
either receiving an internal call of the user after the user enters the second car or generating by the elevator controller a call configured to move the second car to the destination floor, and
moving the second car to the destination floor.

11. The method of claim 10 wherein the elevator controller generates at least two sub-calls in response to the internal call of the user in the incoming scenario.

12. The method of claim 11 wherein the at least two sub-calls comprise at least one of an external call or an internal call concerning a destination floor that is different from the destination floor specified by the user.

13. The method of claim 10 wherein the elevator controller generates at least two sub-calls in response to the destination call of the user in the outgoing scenario.

14. The method of claim 11 wherein the at least two sub-calls comprise at least one of an external call or an internal call concerning a destination floor that is different from the destination floor specified by the user.

15. The method of claim 10 for controlling the elevator installation based on zone operation, wherein the floors that the elevator installation services are subdivided into at least two zones, wherein an interchange floor is provided for a transition between each pair of the at least two zones.

16. The method of claim 10 wherein in a scenario where not every car of the elevator installation can move to every floor of the building, the method comprises:
receiving an external call of a user on a start floor;
providing a first car by the elevator controller on the start floor;
receiving an internal call of the user to a destination floor after the user enters the first car;
recognizing by the elevator controller that the first car cannot travel to the destination floor and generating a modified internal call by the elevator controller to a modified floor to which the first car can move;
generating an external call for the modified floor by the elevator controller;
providing a second car to the modified floor in response to the external call;
either receiving a second internal call of the user to the destination floor after the user enters the second car or generating by the elevator controller a call configured to move the second car to the destination floor; and
moving the second car to the destination floor.

17. The method of claim 10 wherein in a scenario where not every car of the elevator installation can move to every floor of the building, the method comprises:
receiving an external call of a user on a start floor;
providing a first car by the elevator controller on the start floor;
receiving an internal call of the user to a destination floor after the user enters the first car;
recognizing by the elevator controller that the first car cannot travel to the destination floor and generating a modified internal call by the elevator controller to a modified floor to which the first car can move;
generating a destination call for the modified floor by the elevator controller;
providing a second car to the modified floor in response to the destination call; and
moving the second car to the destination floor after the user enters the second car.

18. The method of claim 10 wherein the elevator controller generates a destination call or an internal call in response to an external call of the user.

19. The method of claim 18 wherein the elevator controller generates the destination call or the internal call in response to the external call of the user only if only one unique destination floor is logically possible in a current operating state of the elevator installation.

20. The method of claim 19 wherein when the elevator controller generates an internal call, the elevator controller independently generates the internal call when the user enters one of the cars.

21. The method of claim 19 wherein when the elevator controller generates a destination call, the elevator controller generates the destination call before the user enters the elevator car.

22. The method of claim 19 wherein the elevator installation is operated as a shuttle elevator installation, wherein at least some of the cars of the elevator installation are moved between an entrance level and a transfer floor of the building, wherein the at least some of the cars of the elevator installation can stop at only the entrance level and the transfer floor.

23. A method for processing call inputs with an elevator controller of an elevator installation, the method comprising:
receiving an external call of a user on a start floor;
providing a first car by the elevator controller on the start floor;
receiving an internal call of the user that specifies a destination floor after the user enters the first car;
moving the first car to a transfer floor;
generating a destination call by the elevator controller from the transfer floor to the destination floor;
assigning a second car to the destination call;
providing the second car on the transfer floor; and
moving the second car to the destination floor after the user enters the second car.

24. A method for processing call inputs with an elevator controller of an elevator installation, the method comprising:
receiving a destination call of a user on a start floor, the destination call specifying a destination floor;
generating a sub-destination call by the elevator controller from the start floor to a transfer floor;
providing a first assigned car to the start floor;
moving the first assigned car to the transfer floor;
generating an external call by the elevator controller for the transfer floor;
providing a second car assigned to the external call by the elevator controller to the transfer floor;
either receiving an internal call of the user after the user enters the second car or generating by the elevator controller a call configured to move the second car to the destination floor; and
moving the second car to the destination floor.
